(19) United States
(12) Patent Application Publication
(10) Pub. No.: US 2003/0111324 A1
(43) Pub. Date: Jun. 19, 2003

(54) Modular conveyor

(76) Inventors: Donald S. Thurston, Langley (CA); Gary M. Cardno, Langley (CA)

Correspondence Address: Clifford W. Vermette, Vermette & Co., Box 40 Granville Square, 200 Granville Street, Suite 230, Vancouver, BC, V6C 1S4, CA

(21) Appl. No.: 10/351,504

(22) Filed: Jan. 27, 2003

Related U.S. Application Data
(63) Continuation-in-part of application No. 09/852,617, filed on May 11, 2001, now Pat. No. 6,520,321.

(51) Int. Cl. B65G 23/44

(52) U.S. Cl. 198/813

(57) ABSTRACT

The invention consists of a modular conveyor formed by a number of removably attachable conveyor sections, which form an elongated, endless conveyor. There is a drive section at one end, having a drive motor and a drive roller and an end section having an end roller at the opposite end. A number of intermediate sections are located between the drive section and the end section. Each intermediate section contains a frame, one or more support legs, a coupling mechanism to couple to adjacent sections, and a belt support. The belt support is preferably a roller. An endless conveyor belt is mounted over the frames, the drive roller, and the end roller. The endless conveyor belt also passes between the frame and the belt support and is held at tension by the belt support.

### RELATED APPLICATION

This application is a continuation-in-part of U.S. patent application Ser. No. 09/852,617, filed May 11, 2001, which is herein incorporated by reference.

### FIELD OF THE INVENTION

The invention relates to a modular conveyor composed of a plurality of removably attachable conveyor sections.

### BACKGROUND OF THE INVENTION

Modular conveyors are desirable in industrial applications to allow for temporary deployment in areas where a permanently installed conveyor is not possible. Modular conveyors of this type should be portable and easily assembled in order to maximize efficiency. Other types of modular conveyors have also been designed to address the need for use of conveyors in sharply curved or inclined areas. These designs are highly complex and conveyors built to these designs have not had any significant portability.

U.S. Pat. No. 3,944,054 issued to Ensinger discloses a modular conveyor with a channel-shaped frame and removable legs to allow adjustment from a flat to an inclined conveyor. However, the Ensinger conveyor does not include any guide rollers or other support means to support the conveyor belt, being thus unable to maintain the belt tension required for long conveyors.

U.S. Pat. No. 5,131,531 issued to Chambers discloses a modular conveyor comprised of a series of modular frames and attachments. The frame components are connected alternately with separate attachment components. The conveyor belt is guided by means of guide channels preformed in each component. Correct alignment of these guide channels during assembly is required for proper functioning. The resulting conveyor design requires numerous components and is not suited to operations where repeated disassembly and removal of the conveyor system is required.

U.S. Pat. No. 4,007,827 issued to Mattos demonstrates another problem with “modular” conveyors. The conveyor disclosed by Mattos is described as “modular”, however, the conveyor is actually composed of a number of discrete parts (pedestals, beams, and side rails) that are bolted together to form a conveyor. The Mattos conveyor is not truly modular as there are no separate modules and requires disassembly and reassembly when a new configuration is required. The Mattos type of “modular” conveyor requires more time and manpower to make changes to the conveyor than a truly “modular” system composed of complete conveyor modules that are readily attached and detached from each other.

Another problem arises when a modular conveyor is required to cover uneven terrain, such that the belt is no longer kept on one continuous plane. If the modules are set to different angles, the belt tension over the modules, particularly at the joints, can be reduced, rendering the conveyor non-operable. A similar problem arises when a modular conveyor is extended to lengths over approximately 100 feet, as the belt tension is slackened to the point where there is no longer enough friction with the drive roller for the conveyor to function.

Consequently, there is a need for a less complex conveyor system that can be quickly assembled and disassembled, for use in operations where permanent mounting of the conveyor system is not possible. There is also a need for a portable modular conveyor that allows for very long conveyor lengths in the hundreds of feet. Finally, there is a need for a modular conveyor that meets the previous requirements and, for maximum efficiency, can be assembled, disassembled and modified by a minimum number of people, preferably a single person.

It is an object of this invention to provide a modular conveyor that can be quickly assembled and disassembled.

It is a further object of this invention to provide a modular conveyor that is suitable for very long conveyor systems with belt lengths in the hundreds of feet. It is also an object of this invention to provide a modular conveyor than can maintain belt tension when the modules are positioned at different heights.

It is a still further object of this invention to provide a modular conveyor that can be assembled, disassembled and modified by a minimum number of people, preferably a single person.

### SUMMARY OF THE INVENTION

The invention consists of a modular conveyor formed by a number of removably attachable conveyor sections, which form an elongated, endless conveyor. There is a drive section at one end, having a drive motor and a drive roller and an end section having an end roller at the opposite end. A number of intermediate sections are located between the drive section and the end section. Each intermediate section contains a frame, one or more support legs, a coupling mechanism to couple to adjacent sections, and a belt support. The belt support is preferably a roller. An endless conveyor belt is mounted over the frames, the drive roller, and the end roller. The endless conveyor belt also passes between the frame and the belt support and is held at tension by the belt support.

The frames of the conveyor sections may have longitudinally extending walls to provide additional support and prevent material from leaving the conveyor surface. Preferably, the legs attached to the conveyor sections are longitudinally extensible to vary the lengths of the legs and allow the conveyor to be securely supported on uneven surfaces.

Preferably, there are two legs attached to each frame, located at one end of each conveyor section, with one leg on either side of the frame.

Advantageously, individual conveyor sections may be removably attachable by elongated rods which couple to the corresponding elongated rods on the adjacent sections.

Preferably, the end roller is mounted on an adjustable frame so that the end roller position can be adjusted to maintain tension in the conveyor belt for proper operation. A removable platform may be removably attached to the adjustable frame to provide an area for loading and unloading material from the modular conveyor.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a side view of a drive conveyor section;

FIG. 2 is a side view of an end conveyor section;

FIG. 3 is a side view of an unattached intermediate conveyor section;

FIG. 4 is an end view of an unattached intermediate conveyor section;

FIG. 5 is a top view of a slidable end roller frame; and

FIG. 6 is a perspective view of a modular conveyor.

### DETAILED DESCRIPTION OF THE INVENTION

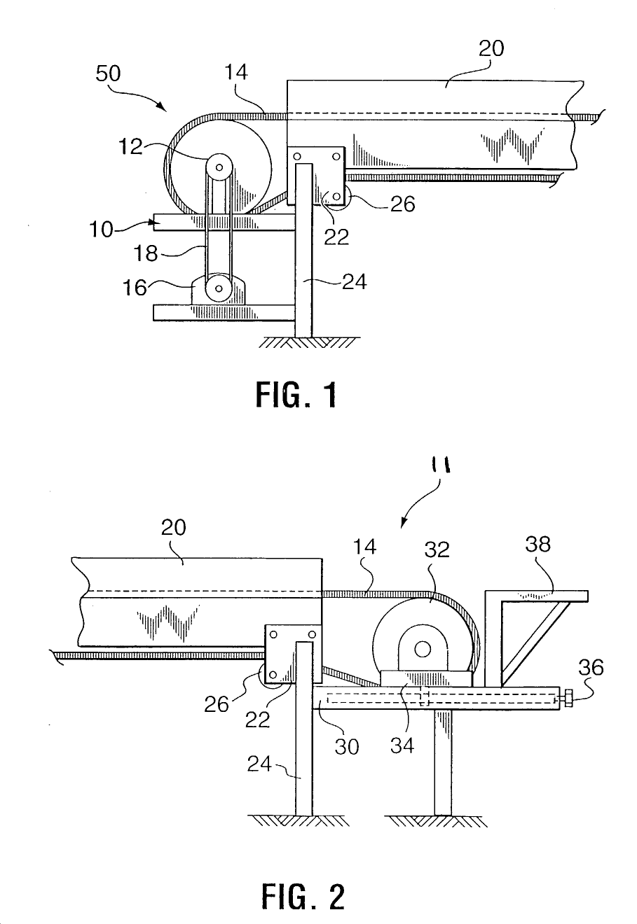

Referring to FIG. 1, one end of the modular conveyor 50 comprises a drive conveyor section 10 with a drive roller 12 that rotates to drive an endless conveyor belt 14. A hydraulic motor 16 and drive chain 18 act as the drive motor, but any means to power rotation of the drive roller 12 may be used. The drive conveyor section 10 is attached to an intermediate conveyor section 20, with a frame 22 and guide rollers 26 to support and guide the endless conveyor belt 14. The conveyor section 20 is supported by support legs 24 attached to frame 22. The endless conveyor belt 14 is a solid fabric or plastic web resistant to the frictional effects of the frame 22 and guide roller 26 such as, for example, polypropylene.

While the hydraulic motor 16 is shown beneath the drive roller 12, any location is possible. For example, the hydraulic motor 16 can be located beneath the frame 22, to reduce the potential for damage caused by material falling off the endless conveyor belt 14. Additionally, a cover (not shown) should be placed over the drive chain 18 to reduce the possibility of loose material or clothing being caught in the drive chain 18 or hydraulic motor 16.

By positioning the guide roller 26 as close to the end of the conveyor section 20 as possible, the distance the endless conveyor belt 14 travels from the end of the conveyor section 20 to the drive roller 12 is minimized. This positioning allows for a greater area of the endless conveyor belt 14 to be gripped by the drive roller 12. A greater gripping area increases the ability of the drive roller 12 to push or pull the endless conveyor belt 14 as required.

Furthermore, the guide roller 26 allows for the diameter of the drive roller 12 to be greatly increased in proportion to the separation distance of two sides of the endless conveyor belt 14. By making the drive roller 12 of a sufficiently large size, the modular conveyor 50 can be used in either a push or a pull fashion, eliminating the need to change the end at which the drive conveyor section 10 is mounted in order to change the direction of motion of the endless conveyor belt 14.

Referring to FIG. 2, the opposite end of the modular conveyor 50 is an end conveyor section 11 comprising an end roller 32 secured to a support platform 30. The end roller 32 is attached to a slidable frame 34 secured to the support platform 30, allowing the tension in endless conveyor belt 14 to be maintained by moving slidable frame 34 longitudinally via threaded fastener 36.

There may also be a removable platform 38 attached to the slidable frame 34 adjacent to the end roller 32. The removable platform 38 allows for material to be stored for loading or unloading from the modular conveyor 50. The removable platform 38 can also be removed from the slidable frame 34 to provide access to the end roller 32 for maintenance. By attaching removable platform 38 to the slidable frame 34 instead of the support platform 30, the removable platform 38 will move together with the end roller 32 when tension is adjusted in the endless conveyor belt 14 by movement of the slidable frame 34. The removable platform 38 should be as close to the end roller 32 as possible to eliminate any gaps that could catch loose material or the clothing of operating personnel.

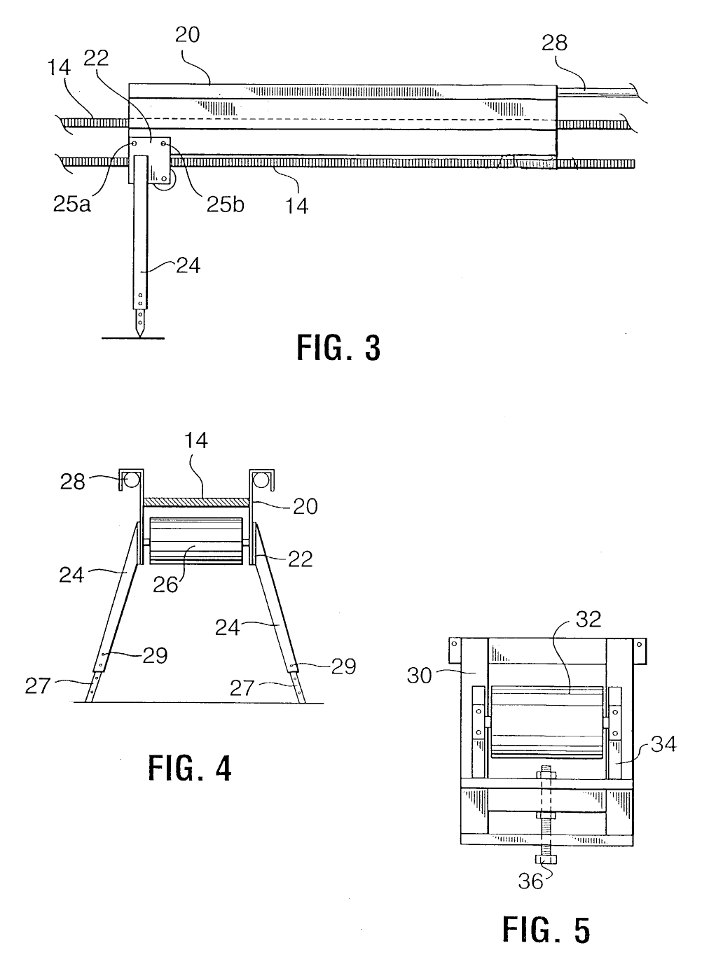

Referring to FIG. 3 and FIG. 4, an intermediate conveyor section 20 includes a pair of attached support legs 24. The support legs 24 are attached to the frame 22 by bolts 25a and 25b. With both support legs 24 located at one end of intermediate conveyor section 20, the other end will be supported by the connection to an adjacent conveyor section. Alternatively, a pair of support legs 24 can be attached at each end of intermediate conveyor section 20, for a total of four legs on each section.

Elongated rods 28 are used to form a connection between two conveyor sections 20. The elongated rods 28 removably couple to a corresponding hole in an adjacent section. While elongated rods 28 represent a preferred means of quickly and easily connecting intermediate conveyor sections 20, any other connection means that allows adjacent conveyor section to abut with no space between adjacent frames 22 is acceptable.

The conveyor belt 14 is supported by the frame 22 and guide roller 26 attached beneath the frame 22. The guide roller 26 acts to support and maintain tension in the conveyor belt 14. While rollers are a preferred means of supporting the conveyor belt 14, any suitable low-friction, wear-resistant component will suffice. For example, a curved metal rod could be used in place of guide roller 26.

Guide roller 26 or a similar belt support is essential for construction of a very long conveyor, on the order of hundreds of feet. Maintaining sufficient tension in conveyor belt 14 is not possible without an adequate number of guide rollers 26. A sample conveyor using 10-foot intermediate conveyor sections 20 with one guide roller 26 per section was fully functional to a length of 320 feet, and lengths up to 500 feet are expected to be possible. The necessary number of guide rollers 26 will depend on the length of the intermediate conveyor sections 20, however, one guide roller per section is optimal for intermediate conveyor sections 20 of 10-12 feet.

Additionally, the guide roller 26 or other belt support allows for the individual modules to be set at different angles and/or heights while the tension in conveyor belt 14 is maintained.

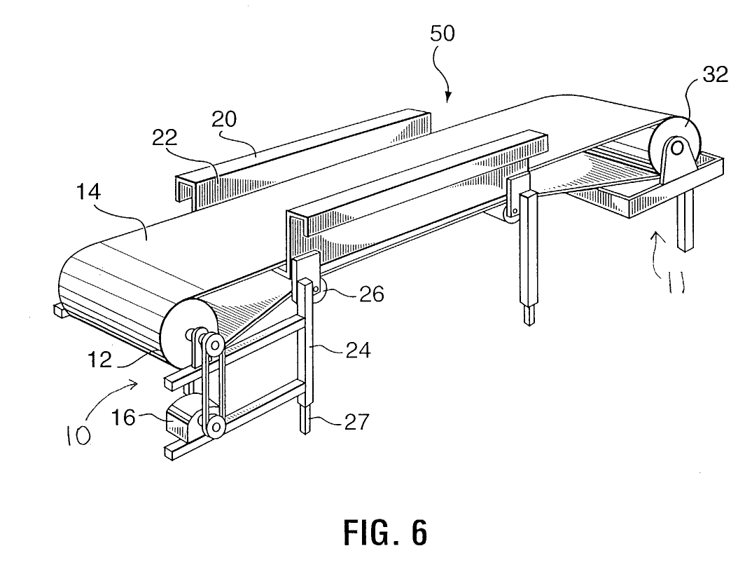

Telescoping leg extensions 27 and adjustment pins 29 permit extension of the support legs 24. While adjustment pins 29 are shown on the sides of support legs 24 in FIG. 4, for some applications it may be desirable to locate adjustment pins 29 on the interior of support legs 24. By locating adjustment pins 29 on the interior of support legs 24, inadvertent contact with persons working in the vicinity of the modular conveyor 50 (see FIG. 6) is prevented. Alternatively, the adjustment pins 29 can be replaced by making telescoping leg extensions 27 screw-threaded (not shown), allowing for more precise control of the total length of support legs 24.

By using elongated rods 28 to connect the conveyor sections 20, the process of adding or removing conveyor sections 20 from a modular conveyor 50 (see FIG. 6) is greatly simplified. Any similar connection means that allows the frames 22 of adjacent intermediate sections 20 to be in contact, such as a buckle on the side walls of the frames 22, will also suffice.

The process can be further simplified by forming endless conveyor belt 14 from pieces that are substantially double the length of an intermediate conveyor section 20. The pieces are connected to each other using known methods, such as end lacing, with a pin for easy removal of the lacing and separation of the belt pieces. Preferably, the belt pieces are custom-designed and cut for an optimal fit to the conveyor sections 20.

Therefore, when a conveyor section 20 is added or removed, a corresponding piece of endless conveyor belt 14 is also added or removed. The effect is that the number of people required to assemble, disassemble and modify the modular conveyor 50 is greatly reduced. It is expected that a modular conveyor 50 using 10-foot long conveyor sections 20 and 20-foot long pieces of endless conveyor belt 14 can be assembled, disassembled and modified by only one person with a reasonable amount of time and effort.

Referring to FIG. 5, on end section 11 (shown in FIG. 2), end roller 32 is connected to slidable frame 34 with threaded fastener 36 providing for adjustment and attachment to the supporting platform 30. The removable platform 38 (see FIG. 2) is not shown in order to provide a clear view of the adjustment mechanism.

Referring to FIG. 6, a fully assembled modular conveyor 50 is composed of a plurality of intermediate conveyor sections 20, a drive section 10 at one end and an end section 11 at the opposite end. Endless conveyor belt 14 is passed over drive roller 12 and end roller 32. Endless conveyor belt 14 is supported for the length of the modular conveyor 50 by the frames 22 and guide rollers 26. Support legs 24 attached to frames 22 support the modular conveyor 50. Telescoping leg extensions 27 permit extension of the support legs 24 to allow for proper support of the modular conveyor 50 on uneven surfaces. Telescoping leg extensions 27 may be screw-threaded, to permit precise control of the length of the support legs 24.

A potential method of application for the portable modular conveyor is in lime production operations. Removal of lime residue from the burner for such a process requires the burner to be shut down so that workers with picks, shovels and wheelbarrows can remove the residue. By using a modular conveyor as disclosed to replace the wheelbarrow chain, the removal can proceed in a more efficient manner. The individual legs 24 allow setting up the modular conveyor 50 on an uneven base such as the rounded floor of a burner. The guide rollers 26 allow for belt tension to be maintained even though individual sections 20 may be set to varying angles and heights. The construction of the burner prevents a permanent conveyor system from being implemented, therefore repeated assembly and disassembly of the conveyor is required.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. A modular conveyor, comprising a number of removably attachable conveyor sections, including:
(a) a drive section at one end of said modular conveyor, having a drive motor and a drive roller;
(b) an end section at an opposite end to said one end of said modular conveyor, having an end roller;
(c) one or more intermediate sections located between said drive section and said end section, each of said intermediate sections comprising:
(i) a frame;
(ii) one or more support legs;
(iii) a coupling mechanism to removable couple each intermediate section to one of: an adjacent intermediate section, said drive section, and said end section; and
(iv) a belt support mounted on and underneath said frame;
(d) an endless belt extending over said drive roller, said frames, and said end roller, and passing between said frames and said belt supports,
wherein said endless belt is supported by said belt supports so that said belt is kept under tension and increases its frictional contact with said drive roller.

2. A modular conveyor according to claim 1, wherein each said frame includes a pair of spaced apart, elongated walls extending proximate to a corresponding side edge of said conveyor belt.

3. A modular conveyor according to claim 1, wherein each of said support legs is extendable longitudinally so as to vary the length of said each leg.

4. A modular conveyor according to claim 1, wherein the number of said support legs is four, with said four legs arranged in pairs, one leg on either side of each said frame and said pairs attached at proximate ends of each said intermediate conveyor section.

5. A modular conveyor according to claim 1, wherein the number of said support legs is two, with one leg on either side of each said frame and said support legs attached proximate one end of each said intermediate conveyor section such that an opposite end of said each intermediate conveyor section is supported by an adjacent conveyor section.

6. A modular conveyor according to claim 1, wherein said coupling mechanism is a pair of elongated rods, at least one end of each of which is removably couplable to a hole in an adjacent intermediate section so as to align each intermediate section with an adjacent intermediate section.

7. A modular conveyor according to claim 1, wherein said end roller is attached to a slidably adjustable frame such that said end roller can be positionally adjusted to maintain tension in said conveyor belt.

8. A modular conveyor according to claim 7, wherein a removable platform is removably attached to said slidable frame.

9. A modular conveyor according to claim 1, wherein said belt support is a roller.

10. A modular conveyor according to claim 1, wherein said belt support is a wear-resistant, curved metal bar.

11. A modular conveyor according to claim 1, wherein said drive motor is removably attachable to said drive section.

12. A modular conveyor according to claim 1, wherein said drive motor is removably attachable to said drive section and said drive motor can be attached to said end section such that said drive section and said end section are interchangeable.
